(19) United States
(12) Patent Application Publication
(10) Pub. No.: US 2022/0314584 A1
(43) Pub. Date: Oct. 6, 2022

(54) COMPOSITE MATERIALS AND METHODS OF PREPARATION THEREOF

(71) Applicant: Westlake Royal Building Products Inc., Houston, TX (US)

(72) Inventors: Hamed LAKROUT, San Antonio, TX (US); Russell L. HILL, San Antonio, TX (US)

(73) Assignee: Westlake Royal Building Products Inc., Houston, TX (US)

(21) Appl. No.: 17/710,446

(22) Filed: Mar. 31, 2022

Related U.S. Application Data
(60) Provisional application No. 63/168,513, filed on Mar. 31, 2021.

(51) Int. Cl. B32B 27/06; B32B 5/18; B32B 27/20; B32B 27/40; B32B 7/12; B32B 7/022

(52) U.S. Cl. CPC B32B 27/065; B32B 5/18; B32B 27/20; B32B 27/40; B32B 7/12; B32B 7/022; B32B 2266/06; B32B 2266/0278; B32B 2307/72; B32B 2307/732; B32B 2419/00; B32B 2264/101; B32B 2264/104; B32B 2307/54

(57) ABSTRACT

Composite materials and methods of use and manufacturing are described herein. The composite materials may include a substrate comprising a polymer composite, the substrate having a density of 2 pcf to 15 pcf; and a facer covering at least a portion of the substrate, the facer including a polymer and a filler, wherein the filler is present in an amount greater than or equal to 50% by weight, with respect to the total weight of the facer.

### CROSS-REFERENCE TO RELATED APPLICATIONS

This application claims priority to U.S. Provisional Application No. 63/168,513, filed on Mar. 31, 2021, which is incorporated herein in its entirety.

### TECHNICAL FIELD

The present disclosure generally relates to composite materials, and methods of use and preparation thereof.

### BACKGROUND

Composite materials are useful for various applications due to their physicochemical properties. While some polymeric composites have desirable mechanical properties such as high levels of compressive strength and flexural strength, such composites can be difficult to form into building materials with the desired characteristics, for example, relatively low density and sufficient strength.

### SUMMARY

The present disclosure includes a composite material comprising a substrate comprising a polymer composite, the substrate having a density of 2 pcf to 15 pcf, and a facer covering at least a portion of the substrate, the facer comprising a polymer and a filler, wherein the filler is present in an amount greater than or equal to 50% by weight, with respect to the total weight of the facer. In some embodiments, the filler of the facer may be a first filler and the polymer composite may comprise a second filler, the first filler being present in an amount of 50% to 98% by weight, with respect to the total weight of the facer and/or the second filler being present in an amount of 5% to 60% by weight, with respect to the total weight of the substrate. The first filler, the second filler, or both, may comprise fly ash, bottom ash, glass microspheres, cenospheres, calcium carbonate, or a combination thereof.

The substrate may have a density of 5 pcf to 10 pcf and/or the facer may have a density of 30 pcf to 200 pcf. The substrate may have an open cell structure, for example, the substrate may have an open cell percentage of 30% to 95%. In some examples, the composite material may have a thickness greater than or equal to 0.25 inch, the facer may be bonded to the substrate with an adhesive or the facer may be directly bonded to the substrate without an adhesive, and/or the composite may have a compressive strength of 30 psi to 150 psi.

Also encompasses herein are building materials comprising the composite materials discussed above and elsewhere herein, wherein the building product may have a planar surface configured to support a porcelain or granite tile.

The present disclosure also includes a composite material comprising a substrate comprising a polymer composite, the substrate having a density of 5 pcf to 10 pcf; and a facer comprising a polymer and a filler, the facer having a density of 50 pcf to 200 pcf, wherein the polymer composite, the polymer, or both, comprise polyurethane. The facer may be directly bonded to the substrate without an adhesive. In some examples, the filler of the facer is a first filler and the polymer composite comprises a second filler, the first filler being present in an amount of 50% to 98% by weight, with respect to the total weight of the facer and/or the second filler being present in an amount of 5% to 60% by weight, with respect to the total weight of the substrate. The first filler, the second filler, or both, may comprise fly ash, bottom ash, glass microspheres, cenospheres, calcium carbonate, or a combination thereof. In some embodiments, the substrate may further comprise a surfactant and/or the substrate may have an open cell structure, for example, an open cell percentage of 30% to 95%.

The present disclosure also includes methods of preparing composite materials. For example, the method may comprise bonding a facer with a substrate to form the composite material, wherein the substrate comprises a polymer composite, the substrate having a density of 2 pcf to 15 pcf, and wherein the facer comprises a polymer and a filler the facer having a density of 50 pcf to 200 pcf. In some examples, the substrate may be a foam composite and the composite material may have a thickness greater than or equal to 0.25 inch. The facer may be directly bonded to the substrate without an adhesive.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., a molecular weight between 250 g/mol and 1000 g/mol includes 250 g/mol, 1000 g/mol, and all values between.

The present disclosure generally includes composite materials. The composite materials herein may be useful as supports (e.g., substrates) for materials such as tile and countertops comprising durable materials like porcelain, ceramics and/or stone, and/or as replacements for such materials. The composite materials herein may be relatively lightweight while having desired properties, e.g., sufficient compressive strength and/or flexural strength.

The composite materials herein may comprise a substrate and a facer, e.g., the substrate comprising a polymer composite foam and the facer comprising a higher density polymer composite. The substrate may be a core of the composite material. In some examples, the substrate may be a core of the composite material between two layers of a facer. The polymer composite may have an open cell structure, as discussed herein. The facer together with the substrate may provide desired structural properties, and greater durability as compared to other polymer-based building materials. The composite materials herein optionally may be prepared to resemble a desired material such as porcelain or other ceramic, or granite or other stone, or the like. For example, the facer may include a design element that provides the aesthetics, feel, and/or durability of a porcelain, ceramic, or stone material, without the corresponding weight or additional labor installation of those materials. According to some aspects of the present disclosure, the substrate and the facer are coupled together, e.g., bonded together, using an adhesive. The adhesive optionally may comprise a polyurethane composite.

The composite materials herein may comprise a polymer composite foam, e.g., a filled polymer composite foam. The polymer of the substrate may comprise a thermosetting polymer. For example, the polymer may comprise an epoxy resin, phenolic resin, bismaleimide, polyimide, polyolefin, polyurethane, polyvinylchloride, polypropylene, polyethylene, polyethylene terephthalate, polyamide, polystyrene, acrylonitrile butadiene styrene, polycarbonate, polyethylenimine, or a combination thereof. In some examples, the polymer comprising polyurethane, e.g., prepared by combining a polyol with an isocyanate, with other components such as fillers or additives. Water or other blowing agent together with surfactants and/or cell openers may be used to produce a polymer composite foam having an open cell structure. The density of the substrate may be 2 pcf to 15 pcf. For example, the density of the substrate may be 2 pcf to 10 pcf, 5 pcf to 10 pcf, or 5 pcf to 15 pcf.

The facer of the composite materials herein may comprise a polymer composite, e.g., comprising a polymer and filler(s). The polymer and/or filler may be the same or different from that of the substrate. In some examples, the facer may have the same chemical components but have a higher density than the substrate, e.g., providing enhanced strength and/or durability to the composite material. To increase density of the facer, for example, the components of the facer may be combined in such a way as to reduce, inhibit, or prevent foaming. For example, the facer may be prepared in absence of a blowing agent, or surfactant and/or cell opener. The density of the facer may be greater than or equal to 30 pcf. For example, the density of the facer may be 30 pcf to 200 pcf, 75 pcf to 200 pcf, 100 pcf to 200 pcf, 125 pcf to 200 pcf, 150 pcf to 200 pcf, 30 pcf to 100 pcf, 30 pcf to 125 pcf, 30 pcf to 150 pcf, or 30 pcf to 175 pcf.

As mentioned above, the composite materials herein may further comprise an adhesive between the substrate and the facer. The adhesive may mechanically and/or chemically bond the facer to the substrate. In at least one example, the adhesive comprises a polymer composite. The polymer composite of the adhesive may comprise a polymer and filler, each of which may be the same or different than the polymer and/or filler of the substrate and/or facer. Other suitable adhesives may include, for example, epoxies, urethanes, acrylate-based adhesives, and acrylic adhesives, and cement, thin set, inorganic-based mortars. In some examples, the composite material does not include an adhesive. For example, the facer may be directly bonded to the substrate without an adhesive (e.g., functional groups of the facer being bonded to functional groups of the facer).

As described herein, the composite materials herein (including the substrate and the facer together with adhesive, if any) have a low or relatively low density. For example, the density of the composite material may be less than or equal to 20 pcf, e.g., 5 pcf to 20 pcf, 10 pcf to 20, or 15 pcf to 20 pcf.

In some examples herein, the substrate, facer, and/or adhesive may comprise polyurethane, e.g., prepared by combining one or more polyols with an isocyanate. Isocyanates suitable for use in preparing the composites herein may include at least one monomeric or oligomeric poly- or di-isocyanate. Exemplary diisocyanates include, but are not limited to, methylene diphenyl diisocyanate (MDI), including MDI monomers, oligomers, and combinations thereof. Factors that may influence the choice of a particular isocyanate can include the overall properties of the foam composite, such as the amount of foaming, strength of bonding to a filler, wetting of inorganic fillers in the mixture, strength of the resulting composite, stiffness (elastic modulus), and reactivity.

The polyol(s) may be in liquid form. For example, liquid polyols having relatively low viscosities generally facilitate mixing. Suitable polyols include those having viscosities of 10000 cP or less at 25° C., such as a viscosity of 150 cP to 10000 cP, 200 cP to 8000 cP, 5000 cP to 10,000 cP, 5000 cP to 8000 cP, 2000 to 6000 cP, 250 cP to 500 cP, 500 cP to 4000 cP, 750 cP to 3500 cP, 1000 cP to 3000 cP, or 1500 cP to 2500 cP at 25° C. Further, for example, the polyol(s) may have a viscosity of 8000 cP or less, 6000 cP or less, 5000 cP or less, 4000 cP or less, 3000 cP or less, 2000 cP or less, 1000 cP or less, or 500 cP or less at 25° C.

The polyols useful for the composites herein may include compounds of different reactivity, e.g., having different numbers of primary and/or secondary hydroxyl groups. In some embodiments, the polyols may be capped with an alkylene oxide group, such as ethylene oxide, propylene oxide, butylene oxide, and combinations thereof, to provide the polyols with the desired reactivity. In some examples, the polyols can include a poly(propylene oxide) polyol including terminal secondary hydroxyl groups, the compounds being end-capped with ethylene oxide to provide primary hydroxyl groups.

The polyol(s) useful for the present disclosure may have a desired functionality. For example, the functionality of the polyol(s) may be 7.0 or less, e.g., 1.0 to 7.0, or 2.5 to 5.5. In some examples, the functionality of the polyol(s) may be 6.5 or less, 6.0 or less, 5.5 or less, 5.0 or less, 4.5 or less, 4.0 or less, 3.5 or less, 3.0 or less, 2.5 or less, and/or 1.0 or greater, 2.0 or greater, 2.5 or greater, 3.0 or greater, 3.5 or greater, or 4.0 or greater, or 4.5 or greater, or 5.0 or greater. The average functionality of the polyols useful for the composites herein may be 1.5 to 5.5, 2.5 to 5.5, 3.0 to 5.5, 3.0 to 5.0, 2.0 to 3.0, 3.0 to 4.5, 2.5 to 4.0, 2.5 to 3.5, or 3.0 to 4.0.

The polyol(s) useful for the composite materials herein may have an average molecular weight of 250 g/mol or greater and/or 3500 g/mol or less. For example, the polyol(s) may have an average molecular weight of 300 g/mol or greater, 400 g/mol or greater, 500 g/mol or greater, 600 g/mol or greater, 700 g/mol or greater, 800 g/mol or greater, 900 g/mol or greater, 1000 g/mol or greater, 1100 g/mol or greater, 1200 g/mol or greater, 1300 g/mol or greater, 1400 g/mol or greater, 1500 g/mol or greater, 1600 g/mol or greater, 1700 g/mol or greater, 1800 g/mol or greater, 1900 g/mol or greater, 2000 g/mol or greater, 2100 g/mol or greater, 2200 g/mol or greater, 2300 g/mol or greater, 2400 g/mol or greater, 2500 g/mol or greater, 2600 g/mol or greater, 2700 g/mol or greater, 2800 g/mol or greater, 2900 g/mol or greater, 3000 g/mol or greater, 3100 g/mol or greater, 3200 g/mol or greater, 3300 g/mol or greater, or 3400 g/mol or greater, and/or 3500 g/mol or less, 3400 g/mol or less, 3300 g/mol or less, 3200 g/mol or less, 3100 g/mol or less, 3000 g/mol or less, 2900 g/mol or less, 2800 g/mol or less, 2700 g/mol or less, 2600 g/mol or less, 2500 g/mol or less, 2400 g/mol or less, 2300 g/mol or less, 2200 g/mol or less, 2100 g/mol or less, 2000 g/mol or less, 1900 g/mol or less, 1800 g/mol or less, 1700 g/mol or less, 1600 g/mol or less, 1500 g/mol or less, 1400 g/mol or less, 1300 g/mol or less, 1200 g/mol or less, 1100 g/mol or less, 1000 g/mol or less, 900 g/mol or less, 800 g/mol or less, 700 g/mol or less, 600 g/mol or less, 500 g/mol or less, 400 g/mol or less, or 300 g/mol or less. In some cases, the one or more polyols have an average molecular weight of 250 g/mol to 1000 g/mol, 500 g/mol to 1000 g/mol, 750 g/mol to 1250 g/mol, 250 g/mol to 3500 g/mol, 500 g/mol to 3000 g/mol, or 750 g/mol to 2500 g/mol.

Polyols useful for the composite materials herein include, but are not limited to, aromatic polyols, polyester polyols, polyether polyols, Mannich polyols, and combinations thereof. Exemplary aromatic polyols include, for example, aromatic polyester polyols, aromatic polyether polyols, and combinations thereof. Exemplary polyester and polyether polyols useful in the present disclosure include, but are not limited to, glycerin-based polyols and derivatives thereof, polypropylene-based polyols and derivatives thereof, and polyether polyols such as ethylene oxide, propylene oxide, butylene oxide, and combinations thereof that are initiated by a sucrose and/or amine group. Mannich polyols are the condensation product of a substituted or unsubstituted phenol, an alkanolamine, and formaldehyde. Examples of Mannich polyols that may be used include, but are not limited to, ethylene and propylene oxide-capped Mannich polyols.

The composite materials herein (e.g., substrate, facer, and/or adhesive) optionally may comprise one or more additional isocyanate-reactive monomers. When present, the additional isocyanate-reactive monomer(s) can be present in an amount of 30% or less, 25% or less, 20% or less, 15% or less, 10% or less, or 5% or less by weight, based on the weight of the one or more polyols. Exemplary isocyanate-reactive monomers include, for example, polyamines corresponding to the polyols described herein (e.g., a polyester polyol or a polyether polyol), wherein the terminal hydroxyl groups are converted to amino groups, for example by amination or by reacting the hydroxyl groups with a diisocyanate and subsequently hydrolyzing the terminal isocyanate group to an amino group. Exemplary isocyanate-reactive monomers include, but are not limited to poly ether polyamines, such as polyoxyalkylene diamine or polyoxyalkylene triamine. The polymer composites herein may comprise an alkoxylated polyamine (e.g., alkylene oxide-capped polyamines) derived from a polyamine and an alkylene oxide. Alkoxylated polyamines may be formed by reacting a suitable polyamine (e.g., monomeric, oligomeric, or polymeric polyamines) with a desired amount of an alkylene oxide.

The substrate, facer, and/or adhesive may be prepared with a catalyst, e.g., to facilitate curing and control curing times. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth. The amount of catalyst in the mixture may be 0.01% to 2% based on the weight of the mixture used to prepare the polymer of the composite (e.g., the mixture comprising the isocyanate(s), the polyol(s), and other materials such as foaming agents, surfactants, chain-extenders, crosslinkers, coupling agents, UV stabilizers, fire retardants, antimicrobials, anti-oxidants, cell openers, and/or pigments). For example, the amount of catalyst may be 0.05% to 0.5% by weight, or 0.1% to 0.25% by weight, based on the weight of the mixture used to prepare the polymer composite. In some embodiments, the mixture may comprise between 0.05 and 0.5 parts per hundred parts of polyol.

As mentioned above, the composite materials herein may comprise a filler, such as an inorganic filler material. Examples of fillers useful for the polymer composites herein (e.g., fillers for the substrate, facer, and/or adhesive) include, but are not limited to, fly ash, bottom ash, amorphous carbon (e.g., carbon black), silica (e.g., silica sand, silica fume, quartz), glass (e.g., ground/recycled glass such as window or bottle glass, milled glass, glass spheres and microspheres, glass flakes), calcium, calcium carbonate, calcium oxide, calcium hydroxide, aluminum, aluminum trihydrate, clay (e.g., kaolin, red mud clay, bentonite), mica, talc, wollastonite, alumina, feldspar, gypsum (calcium sulfate dehydrate), garnet, saponite, beidellite, granite, slag, antimony trioxide, barium sulfate, magnesium, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, hollow plastic spheres, expanded plastic beads, ground tire rubber, cenospheres, or mixtures thereof. In some examples, the polymeric material comprises one or more fiber materials. Other exemplary fillers include fiber materials, e.g., natural and synthetic fibers based on inorganic or organic materials. Exemplary fiber materials include, but are not limited to, glass fibers (fiberglass), silica fibers, carbon fibers, metal fibers, mineral fibers, organic polymer fibers, cellulose fibers, biomass fibers, and combinations thereof.

In some embodiments, the filler may comprise an ash produced by firing fuels including coal, industrial gases, petroleum coke, petroleum products, municipal solid waste, paper sludge, wood, sawdust, refuse derived fuels, switchgrass, or other biomass material. For example, the filler may comprise a coal ash, such as fly ash, bottom ash, or combinations thereof. Fly ash is generally produced from the combustion of pulverized coal in electrical power generating plants. In some examples herein, the composite comprises fly ash selected from Class C fly ash, Class F fly ash, or a mixture thereof. In some embodiments, the filler consists of or consists essentially of fly ash.

The substrate may comprise filler(s) in an amount less than or equal to 60% by weight, with respect to the total weight of the substrate. For example, the amount of filler in the substrate may be 5% to 60% by weight, e.g., 10% to 55% by weight, 15% to 50% by weight, 30% to 55% by weight, or 35% to 60% by weight.

The facer may comprise filler(s) in an amount greater than or equal to 50% by weight, with respect to the total weight of the facer. For example, the amount of filler in the facer may be 50% to 98% by weight, e.g., 60% to 98% by weight, 70% to 98% by weight, 80% to 98% by weight, or 90% to 98% by weight.

When the adhesive comprises filler(s) (e.g., the adhesive comprising a polymer composite), the filler(s) may be present in an amount of greater than zero to less than or equal to 80% by weight, such as 5% to 60% by weight, 25% to 75% by weight, 30% to 65% by weight, 30% to 60% by weight, or 45% to 70% by weight, relative to the total weight of the adhesive.

As mentioned above, the filler(s) of the facer may be the same or different from the filler(s) of the substrate and/or the filler(s) of the adhesive. For example, the facer may comprise a first filler and the substrate may comprise a second filler, wherein the first filler is the same or different from the second filler. The adhesive may comprise a third filler that is the same or different from the first and/or second filler. In at least one example, the first filler, the second filler, the third filler, independently may comprise fly ash, bottom ash, glass microspheres, fiberglass, cenospheres, calcium carbonate, or a combination thereof.

The polymer composites herein (substrate, facer, and/or adhesive) may comprise at least one additional material, such as, e.g., foaming agents, surfactants, chain-extenders, crosslinkers, coupling agents, UV stabilizers, fire retardants, antimicrobials, anti-oxidants, cell openers, and/or pigments. The substrate may be prepared as a foam using chemical blowing agents, physical blowing agents, or a combination thereof. If a blowing agent is present in the polymer composite, the amount of blowing agent may be present in an amount of less than 1 part per hundred, relative to the total weight of the polymeric material. Exemplary blowing agents include, e.g., chemical blowing agents like water, and physical blowing agents like carbon dioxide and pentane.

The composite materials herein may be prepared by combining a substrate with a facer, e.g., which may be prepared separately or as part of the same manufacturing process. According to some aspects, the substrate and the facer may be prepared separately with desired dimensions and then adhered together with or without an adhesive to form a planar sheet (in any shape for example a rectangular shape having a length, a width, and a thickness) to be shaped and/or cut to a desired length, width, and thickness (depth). A person of ordinary skill in the art will recognize that the composite need not be prepared in sheet-like form and other dimensions and shapes than those provided above are encompassed herein.

For example, the substrate may be prepared by combining one or more polyols with an isocyanate and filler(s) to form a polymer mixture, which may then produce a polyurethane composite foam via a free rise molding process. For example, a mold may be used to produce the substrate with the desired dimensions. A blowing agent such as water may be used to trap gas within the matrix during the foaming process and establish a structure of cells. Further, components such as surfactants and cell openers may be used to produce the desired cell structure. For example, the substrate may be prepared so as to have an open cell structure and concentrate the polymer composite material into fewer but thicker walls. In turn, this structure is expected to increase the compressive strength of the substrate. Larger open cells may provide for thicker wall cell structure and mechanically stronger material.

The cell content can be measured by ASTM D6226-15. Cell structure can also be assessed using a pycnometer, which calculates the volume and density of a sample by feeding helium into a closed chamber with the sample inside. With the known values of sample mass, volume of the empty chamber, and mass and density of the helium, the pycnometer calculates the volume and density of the sample inside. For a porous material, closed cells of the material block helium from entering the sample and result in a larger measured volume and lower corresponding density, as compared to a sample having a higher open cell percentage. The volume of open cells may be calculated by subtracting the volume measured by the pycnometer, from the geometric volume measured manually (e.g., with calipers, ignoring surface pits or open cells):

V_{OpenCells}=V_{Geometric}−V_{Pyconometer} Equation 1

The open cell percentage may be calculated by dividing the volume of open cells by the geometric volume:

$$\% {Cell}_{open} = ( \frac{{V}_{OpenCells}}{{V}_{G e o m e t r i c}} ) \times 100 \% \qquad Equation 2$$

According to some aspects of the present disclosure, the substrate may have an open cell percentage of at least 5%, such as 5% to 95%, 10% to 95%, 20% to 95%, 30% to 95%, 40% to 95%, 50% to 95%, 60% to 95%, 50% to 80%, 20% to 60%, or 65% to 85%. Additionally, or alternatively, the thickness of the open cell walls may be 50 microns to 100 microns, as opposed to a thickness of about 10 microns for closed cell walls. The thickness of the cell walls is a result of the aggregation of polyurethane into fewer cell walls. In some examples herein, the substrate has a coarse cell structure, e.g., a smaller number of cells with a relatively large cell size.

The facer may be prepared separately, e.g., by combining one or more polyols with an isocyanate and filler(s). Unlike the substrate, the facer may be prepared in a manner so as to prevent, inhibit, or reduce foaming, e.g., to provide for a denser polymer composite material. For example, the facer may be prepared without blowing agents and/or surfactants. The facer may prepared in a single batch (e.g., combining the polyol, isocyanate, and filler in a single mixture). Alternatively, the substrate and/or facer may be prepared from a first component that includes the polyol and a portion of the filler, and a second component that includes the isocyanate and a second portion of the filler. Each of the first and second components may have a paste-like or semi-solid consistency or viscosity. The first and second components then may be combined, e.g., by extrusion or other process suitable for mixing the viscous components. Once the polyol component and isocyanate components are in contact, they may react to form the polymer (polyurethane) composite. The resulting mixture may be shaped into a sheet or other suitable shape before the reaction is complete, e.g., to be added to the core polymer composite foam.

The facer (prepared in a batch or two-component process as described above) may cover one or more surface of the substrate, e.g., covering a front surface, a back surface opposite the front surface, and/or one or more side surfaces. For example, the facer may cover at least one surface or only one surface of the substrate (e.g., the front surface).

As mentioned above, the facer may include at least one design element configured to resemble various building materials, for example, porcelain, granite, or the like. In some examples, one or more surfaces of the composite material may comprise, consist of, or consist essentially of the facer, which provides the design element(s). Optionally, the opposite surface and/or one or more adjacent surfaces also may include a facer. In some examples herein, only one surface includes a facer (e.g., only the front surface and not the back surface). That is, the back surface of the composite panel is defined by the substrate without a facer or coating.

In some examples, the facer is placed in direct contact with the substrate before reactions of the substrate and/or facer are complete, such that functional groups of the substrate are available to chemically bond to functional groups of the facer. In such cases, the composite material does not include an adhesive. In an exemplary manufacturing process, the facer may be added to a mold (e.g., coating one or more surfaces of the mold), and a polymer mixture added on top of the facer to form the substrate by free rise foaming.

In other examples, the substrate is at least partially coated with an adhesive and then the facer added, so that the adhesive is between the substrate and the facer. The adhesive may comprise a polymer composite, an epoxy, a urethane, an acrylate-based adhesive, an acrylic adhesive, or other adhesive suitable for building materials. When the adhesive comprises a polymer composite such as a polyurethane composite, the adhesive may be prepared by combining one or more polyols with an isocyanate and filler(s). Before the reaction between the polyol and isocyanate is complete, the adhesive may be placed between the substrate and the facer, such that the adhesive bonds the facer to the substrate as the reaction proceeds.

The composite materials herein may be used in building materials and products, including as a support for other components of building materials and products. For example, the composite material may be used in a tile, countertop, wall, floor, tub, as well as other interior structures. The composite material or building product comprising the composite material may have a planar surface configured to support a porcelain or granite tile. Further, for example, the composite materials herein may include at least one design element that resembles a desired material and/or texture such as porcelain, granite or other stone, or the like. The composite materials herein may be durable and/or lightweight.

The composite materials herein can be prepared with any desired dimension or shape. The composite material may have a length ranging from 1 inch to 12 feet, for example, from 1 inch to 12 inches, 2 inches to 10 inches, 4 inches to 8 inches, 1 inch to 7 feet, 1 inch to 11 feet, 1 foot to 10 feet, 1 foot to 8 feet, 1 foot to 7 feet, 1 foot to 6 feet, 1 foot to 5 feet, 1 foot to 4 feet, or 1 foot to 3 feet.

The composite material may have a width ranging from 1 inch to 8 feet, for example, from 1 inch to 12 inches, 2 inches to 10 inches, 4 inches to 8 inches, 1 inch to 7 feet, 1 foot to 7 feet, 1 foot to 6 feet, 1 foot to 5 feet, 1 foot to 4 feet, or 1 foot to 3 feet.

In some examples, the substrate may have a thickness greater than or equal to 0.25 inches or greater than or equal to 1 inch. For example, the thickness of the substrate may be 0.25 inches to 3 inches, 0.5 inches to 2.5 inches, 0.8 inches to 2.5 inches, 1 inch to 2 inches.

Further, for example, the facer may have a thickness greater than or equal to 0.02 inches, e.g., 0.05 inches to 0.8 inch, such as 0.05 inches to 0.5 inches. The adhesive, when used, may provide an added thickness of 0.05 inches or less, e.g., less than 0.01 inches.

Thus, for example, the composite material as a whole (including the substrate and facer, and adhesive if any) may have a thickness (depth) ranging from about 0.25 inches to about 4 inches, 0.5 inches to 3 inches, 0.75 inches to 2 inches, or from 1 inch to 3 inches. In a non-limiting example, the composite material is 4 feet in width, 8 feet in length, and 1 inch in thickness. In another non-limiting example, the composite material is 3 feet in width, 5 feet in length, and 1 inch in thickness.

The composite materials may weigh less than materials of similar dimensions comprising porcelain, granite, or the like. The composite materials discussed herein may be configured to have an aesthetic appearance and texture similar to heavier and bulkier building materials such as porcelain and granite (e.g., comprising a facer that includes a design element as discussed herein), while being relatively lightweight and low density as compared to other building materials. Low density materials, such as a low density foam composite, allows for the manufacture of materials that are larger than the above-mentioned building materials without a corresponding increase in weight. For example, porcelain or granite panels may be more difficult to move and install as compared to composite materials described herein that have similar or the same dimensions.

The composite materials herein may have a compressive strength of 30 psi to 150 psi, such as 50 psi to 100 psi, 30 psi to 75 psi, 40 psi to 95 psi, 85 psi to 125 psi, or 110 psi to 145 psi. Compressive strength can be measured by the stress measured at the point of permanent yield, zero slope, or significant change of the stress variation with strain on the stress-strain curve as measured according to ASTM D1621.

Additionally or alternatively, the composite materials may have a flexural strength of 50 psi to 100 psi, such as 50 psi to 75 psi, 60 psi to 95 psi, 55 psi to 80 psi, or 70 psi to 95 psi. Flexural strength can be measured as the load required to fracture a rectangular prism loaded in the three point bend test as described in ASTM C947, wherein flexural modulus is the slope of the stress/strain curve at low strain.

The composite materials herein may combine density properties with desired compressive strength and flexural strength, such that the composite materials may be suitable for use in building products. For example, the composite materials herein may have compressive strength, flexural strength, and/or other mechanical properties comparable to materials such as porcelain, granite, and other mineral-based materials.

While principles of the present disclosure are described herein with reference to illustrative aspects for particular applications, the disclosure is not limited thereto. Those having ordinary skill in the art and access to the teachings provided herein will recognize additional modifications, applications, aspects, and substitution of equivalents that all fall in the scope of the aspects described herein. Accordingly, the present disclosure is not to be considered as limited by the foregoing description.

### EXAMPLES

The following example is intended to illustrate the present disclosure without being limiting in nature. It is understood that the present disclosure encompasses additional embodiments consistent with the foregoing description and following example.

### Example 1

The following composite material comprising a substrate, a facer, and an adhesive between the substrate and the facer was prepared in accordance with the present disclosure as summarized below. Table 1 lists the composition of the substrate, the facer, and the adhesive.

TABLE 1

| | Substrate (% wt.) | Facer (% wt) | Adhesive (% wt.) |
|---|---|---|---|
| Polyol | 19 | 9 | 24 |
| Isocyanate | 30 | 9 | 26 |
| Surfactant | 0.38 | — | — |
| Blowing agent | 0.6 | — | — |
| Catalyst | 0.009 | — | — |
| Filler(s) | 50 | 82 | 50 |

Briefly, the substrate was prepared by combining the polyol, surfactant (e.g., including a cell opener), isocyanate, blowing agent (e.g., water), and filler (e.g., fly ash) to form a mixture. The mixture was placed into a mold and allowed to free rise into an open-cell polyurethane composite foam of dimensions 5 ft.×3 ft.×0.9 inch and having a density of 5-15 pcf.

The facer was prepared by combining the polyol, solubilizer, and half of the filler (e.g., fly ash, fiber glass, and calcium carbonate) to form a first paste-like composition. The isocyanate and other half of the filler were combined to form a second paste-like composition. The first and second paste-like compositions were then combined and extruded into a polyurethane composite sheet of dimensions 5 ft.×3 ft.×0.05 inch and having a density of 90-100 pcf.

The adhesive was prepared by combining the polyol, isocyanate, and filler (e.g., fly ash). Before the reaction between the polyol and isocyanate was complete, the adhesive was placed between the substrate and the facer. As the reaction proceeds, the adhesive bonded the facer to the substrate.

The resulting composite material had dimensions of 5 ft.×3 ft.×1 inch and a density of 15-20 pcf. The composite material, made of an open-cell foam substrate and a highly filled polymer composite facer, may be useful in various building materials, such as a support or substrate for porcelain and other ceramic materials (e.g., tile, countertop), exhibiting sufficient compressive and flexural strength, as well as water and mold resistance.

It is intended that the specification be considered as exemplary only, with a true scope and spirit of the present disclosure being indicated by the following claims.

What is claimed is:

1. A composite material comprising:
a substrate comprising a polymer composite, the substrate having a density of 2 pcf to 15 pcf; and
a facer covering at least a portion of the substrate, the facer comprising a polymer and a filler, wherein the filler is present in an amount greater than or equal to 50% by weight, with respect to the total weight of the facer.

2. The composite material of claim 1, wherein the filler of the facer is a first filler and the polymer composite comprises a second filler, the first filler being present in an amount of 50% to 98% by weight, with respect to the total weight of the facer and/or the second filler being present in an amount of 5% to 60% by weight, with respect to the total weight of the substrate.

3. The composite material of claim 2, wherein the first filler, the second filler, or both, comprise fly ash, bottom ash, glass microspheres, cenospheres, calcium carbonate, or a combination thereof.

4. The composite material of claim 1, wherein the substrate has a density of 5 pcf to 10 pcf.

5. The composite material of claim 1, wherein the facer has a density of 30 pcf to 200 pcf.

6. The composite material of claim 1, wherein the substrate has an open cell structure, for example the substrate having an open cell percentage of 30% to 95%.

7. The composite material of claim 1, wherein the composite material has a thickness greater than or equal to 0.25 inch.

8. The composite material of claim 1, wherein the facer is bonded to the substrate with an adhesive, or wherein the facer is directly bonded to the substrate without an adhesive.

9. The composite material of claim 1, wherein the composite has a compressive strength of 30 psi to 150 psi.

10. A building product comprising the composite material of claim 1, wherein the building product has a planar surface configured to support a porcelain or granite tile.

11. A composite material comprising:
a substrate comprising a polymer composite, the substrate having a density of 5 pcf to 10 pcf; and
a facer comprising a polymer and a filler, the facer having a density of 50 pcf to 200 pcf,
wherein the polymer composite, the polymer, or both, comprise polyurethane.

12. The composite material of claim 11, wherein the facer is directly bonded to the substrate without an adhesive.

13. The composite material of claim 11, wherein the filler of the facer is a first filler and the polymer composite comprises a second filler, the first filler being present in an amount of 50% to 98% by weight, with respect to the total weight of the facer and/or the second filler being present in an amount of 5% to 60% by weight, with respect to the total weight of the substrate.

14. The composite material of claim 13, wherein the first filler, the second filler, or both, comprise fly ash, bottom ash, glass microspheres, cenospheres, calcium carbonate, or a combination thereof.

15. The composite material of claim 11, wherein the substrate further comprises a surfactant.

16. The composite material of claim 11, wherein the substrate has an open cell structure, for example having an open cell percentage of 30% to 95%.

17. A method of preparing a composite material, the method comprising bonding a facer with a substrate to form the composite material;
wherein the substrate comprises a polymer composite, the substrate having a density of 2 pcf to 15 pcf; and
wherein the facer comprises a polymer and a filler, the facer having a density of 50 pcf to 200 pcf.

18. The method of claim 17, wherein the substrate is a foam composite.

19. The method of claim 17, wherein the composite material has a thickness greater than or equal to 0.25 inch.

20. The method of claim 17, wherein the facer is directly bonded to the substrate without an adhesive.
